(19) United States
(12) Patent Application Publication
(10) Pub. No.: US 2025/0043181 A1
(43) Pub. Date: Feb. 6, 2025

(54) FIBROUS SOIL AMENDMENT TO PROMOTE AGRICULTURAL CROP OR PLANT GROWTH

(71) Applicant: Owens Corning Intellectual Capital, LLC, Toledo, OH (US)

(72) Inventor: David H. Wolf, Newark, OH (US)

(21) Appl. No.: 18/783,568

(22) Filed: Jul. 25, 2024

Related U.S. Application Data
(60) Provisional application No. 63/516,884, filed on Aug. 1, 2023.

(51) Int. Cl. C09K 17/04; C03C 3/062; C03C 3/083; C03C 13/00; C09K 17/08; D04H 1/4218; D04H 1/4382; D04H 1/44; D04H 1/58

(52) U.S. Cl. CPC C09K 17/04; C03C 3/062; C03C 3/083; C03C 13/00; C09K 17/08; D04H 1/4218; D04H 1/43838; D04H 1/44; D04H 1/58; C03C 2213/00; D10B 2401/021; D10B 2401/022; D10B 2505/204

(57) ABSTRACT

Systems for and methods of using glass fibers as a soil-based additive to enhance crop and plant growth are disclosed. By replacing a volumetric portion of the soil with the fibers, the plant-available water (PAW) of the amended soil is increased.

### CROSS-REFERENCE TO RELATED APPLICATION

This application claims priority to and any benefit of U.S. Provisional Application No. 63/516,884, filed Aug. 1, 2023, the content of which is incorporated herein by reference in its entirety.

### FIELD

The general inventive concepts relate to systems for and methods of using a fibrous media as a soil amendment to promote agricultural crop or plant growth.

### BACKGROUND

Glass fibers have been widely used in building materials, biomaterials, and composite materials. A glass fiber has a manipulatable and controllable fiber diameter, aspect ratio (i.e., the ratio of the fiber's length to the fiber's diameter), and morphology, as well as chemistry and surface properties, depending on the process used to manufacture the glass fiber. These properties may allow glass fibers, including stone wool and slag wool, to be beneficial to agricultural applications. For example, glass fibers, when manufactured in a mat form, have been used to control the erosion of soil against heavy rain and slippage due to sandy soil, the success of which can be attributed to the high aspect ratio of the glass fibers. Other conventional materials (e.g., soil amendments) used to promote plant/crop growth include, for example, super absorbent polymers (SAPs), silicas, biochar, and mulch.

### SUMMARY

In view of the above, systems for and methods of using fiberglass to increase the plant-available water (PAW) of a soil to promote agricultural crop or plant growth are disclosed. Additionally, the fibrous media may provide other benefits, such as supporting seed germination and facilitating nutrient delivery for agricultural crop or plant growth. The inventive fiber-based materials, including the systems and methods utilizing the materials, achieve comparable or better results than conventional approaches and materials, and do so at a reduced cost, at a reduced dosage, and/or while avoiding one or more drawbacks associated with the conventional approaches and materials.

The general inventive concepts relate to a fiber-based material for introduction into a soil to increase the plant-available water (PAW) of the soil, thereby promoting agricultural crop or plant growth. In this disclosure, a series of glass compositions, as well as auxiliary organic materials to enable various forms of these fibers, are disclosed primarily focusing on agricultural applications.

To further illustrate various aspects of the general inventive concepts, several exemplary embodiments of fiber-based materials (e.g., a nodule, a mat) are disclosed.

In one exemplary embodiment, a soil amendment for promoting the growth of a plant is disclosed. The soil amendment comprises: a plurality of discrete glass fibers, wherein the glass fibers have an average fiber diameter in the range of about 1 μm to about 5 μm; wherein the soil amendment has a density in the range of about 240.28 kg/m³ to about 720.83 kg/m³; and wherein the soil amendment is operable to increase the plant-available water level of the soil (e.g., by about 30% or more).

In some exemplary embodiments, the glass fibers have an average fiber diameter in the range of about 2 μm to about 4 μm; and the soil amendment has a density in the range of about 272.31 kg/m³ to about 688.79 kg/m³.

In some exemplary embodiments, the glass fibers have an average fiber diameter of about 3 μm; and the soil amendment has a density in the range of about 320.37 kg/m³ to about 640.74 kg/m³.

In some exemplary embodiments, the glass fibers have an average fiber diameter of about 3 μm; and the soil amendment has a density in the range of about 304.35 kg/m³ to about 656.76 kg/m³.

In some exemplary embodiments, the glass fibers comprise about 20 wt. % to about 75 wt. % of SiO₂, about 1 wt. % to about 15 wt. % of Al₂O₃, and about 2 wt. % to about 25 wt. % of Na₂O.

In some exemplary embodiments, the glass fibers have a ratio of Si to (Si+Al) greater than about 0.7.

In some exemplary embodiments, the glass fibers form a plurality of nodules having an average largest linear dimension in the range of about 1 mm to about 10 mm. In some exemplary embodiments, each of the nodules has a spherical shape and the largest linear dimension is a diameter of the spherical shape.

In some exemplary embodiments, the glass fibers form a non-woven mat having a width, a length, and a thickness. In some exemplary embodiments, the width is in the range of about 10 mm to about 1 m; the length is in the range of about 10 mm to about 1,000 m; and the thickness is in the range of about 1 mm to about 50 mm.

In some exemplary embodiments, the glass fibers of the mat are held together by a binder. In some exemplary embodiments, the glass fibers of the mat are held together by mechanical entanglement.

In some exemplary embodiments, the soil amendment further comprises an additive applied to a surface of the glass fibers.

In some exemplary embodiments, the additive is at least one of a herbicide, an insecticide, a nematicide, and a fungicide. In some exemplary embodiments, the additive is a hormone. In some exemplary embodiments, the additive is an agricultural biological. In some exemplary embodiments, the additive is a surfactant.

In some exemplary embodiments, the glass fibers of the soil amendment comprise a quantity of hydrophilic fibers and a quantity of hydrophobic fibers.

In one exemplary embodiment, a soil amendment for promoting the growth of a plant is disclosed. The soil amendment comprises: a plurality of discrete glass fibers; wherein the fibers comprise about 20 wt. % to about 75 wt. % of SiO₂, about 1 wt. % to about 30 wt. % of Al₂O₃, and about 1 wt. % to about 25 wt. % of Na₂O; wherein the fibers have a ratio of Si to (Si+Al) greater than about 0.5; wherein the fibers have an average fiber diameter in the range of 1 μm to 5 μm; wherein the soil amendment has a density in the range of about 240.28 kg/m³ to about 720.83 kg/m³; and wherein the soil amendment is operable to increase the plant-available water level of the soil (e.g., by about 30% or more).

In some exemplary embodiments, the glass fibers further comprise about 0.01 wt. % to about 20 wt. % of CaO.

In some exemplary embodiments, the glass fibers further comprise about 0.01 wt. % to about 10 wt. % of MgO.

In some exemplary embodiments, the glass fibers further comprise about 0.01 wt. % to about 15 wt. % of Fe₂O₃ or FeO.

In some exemplary embodiments, the glass fibers further comprise about 0.01 wt. % to about 30 wt. % of B₂O₃.

In some exemplary embodiments, the glass fibers further comprise about 0.01 wt. % to about 25 wt. % of K₂O.

In some exemplary embodiments, the glass fibers further comprise about 0.01 wt. % to about 10 wt. % of P₂O₅.

In some exemplary embodiments, the glass fibers further comprise about 0.01 wt. % to about 10 wt. % of MnO or MnO₂.

In some exemplary embodiments, the glass fibers of the mat are held together by a binder.

In some exemplary embodiments, the glass fibers of the mat are held together by mechanical entanglement.

In some exemplary embodiments, the soil amendment further comprises an additive applied to a surface of the glass fibers. In some exemplary embodiments, the additive is at least one of a herbicide, an insecticide, a nematicide, and a fungicide. In some exemplary embodiments, the additive is a hormone. In some exemplary embodiments, the additive is an agricultural biological. In some exemplary embodiments, the additive is a surfactant.

In some exemplary embodiments, the additive makes the glass fibers more hydrophilic. In some exemplary embodiments, the additive makes the glass fibers more hydrophobic.

In one exemplary embodiment, a method of promoting the growth of a plant is disclosed. The method comprises: placing a seed corresponding to the plant within a quantity of a soil; and placing a soil amendment comprising a plurality of discrete glass fibers in the soil in proximity to the seed; wherein the soil amendment replaces about 15% to about 50% by volume of the soil; wherein the fibers comprise about 20 wt. % to about 75 wt. % of SiO₂, about 1 wt. % to about 30 wt. % of Al₂O₃, and about 1 wt. % to about 25 wt. % of Na₂O; wherein the fibers have a ratio of Si to (Si+Al) greater than about 0.5; wherein the fibers have an average fiber diameter in the range of about 1 μm to about 5 μm; wherein the soil amendment has a density in the range of about 240.28 kg/m³ to about 720.83 kg/m³; and wherein the soil amendment is operable to increase the plant-available water level of the soil (e.g., by about 30% or more).

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1A is a front elevational view of a fiberglass nodule for promoting plant growth, according to one exemplary embodiment.

FIG. 1B is a perspective view of a fiberglass mat for promoting plant growth, according to one exemplary embodiment.

FIG. 2 is a graph showing the relationship between the density of the fiberglass media and the water holding capacity of the fiberglass media with no suction pressure applied.

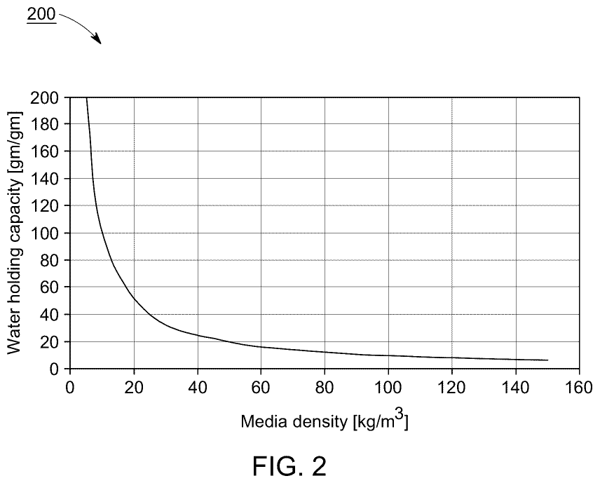

FIG. 3 is a graph showing the relationship between the fiber diameter, the product of the nodule density and the nodule diameter, and the ratio of the fiber surface area to the nodule surface area of the fiberglass media.

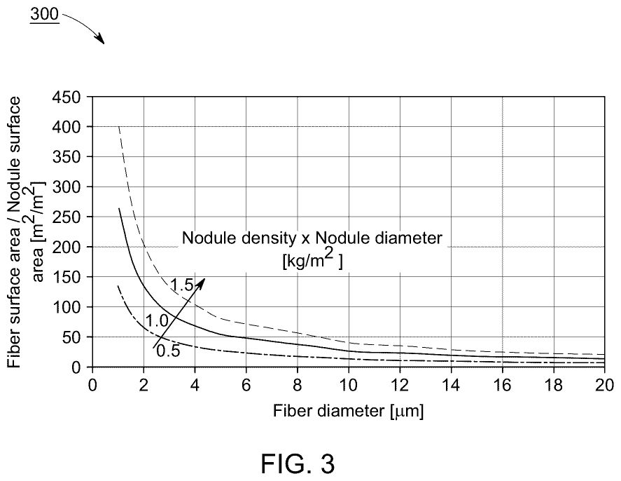

FIG. 4 is a diagram showing the soil water characteristic curve (SWCC), highlighting the parameters of field capacity, wilting point, and plant-available water (PAW).

FIG. 5 is a graph showing normalized plant-available water (PAW) as a function of percent volume of glass fibers (having 3 μm nominal diameter and 320.27 kg/m³ bulk density).

### DETAILED DESCRIPTION

Unless defined otherwise, all technical and scientific terms used herein have the same meanings as commonly understood by one of ordinary skill in the art to which this invention belongs. The term “about,” as used herein to modify any numerical values, encompasses the specific numerical value(s) without any modification, as well as reasonable deviations that still achieve the particular purpose associated with the values (e.g., increasing the PAW).

All references, publications, patents, patent applications, and commercial materials mentioned herein are incorporated herein by reference for all purposes including for describing and disclosing the methodologies which are reported in the publications which might be used in connection with the invention. Nothing herein is to be construed as an admission that the invention is not entitled to antedate such disclosure by virtue of prior invention.

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts encompass a fiber-based soil amendment. The fibrous media can take any suitable form.

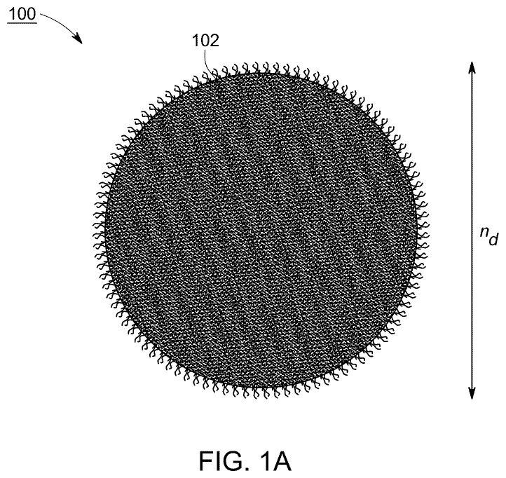

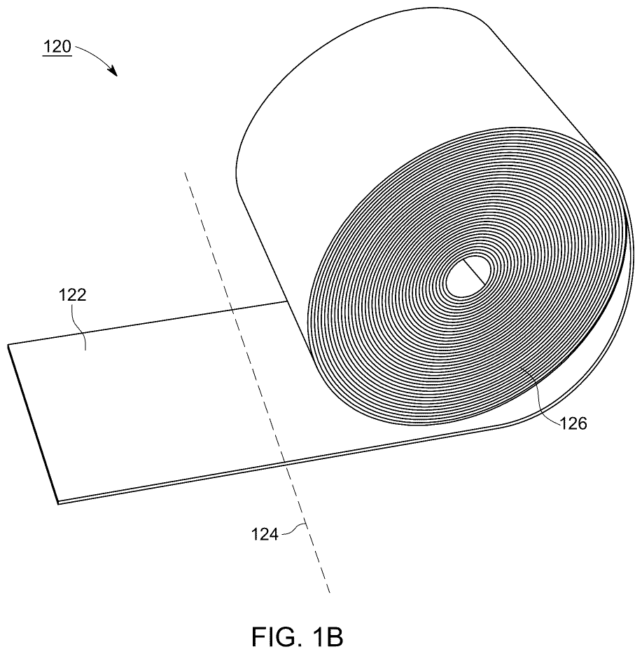

In one exemplary embodiment, the fibrous (e.g., fiberglass) media 100 is a nodule 102, as shown in FIG. 1A. The nodule 102 is generally an irregularly-shaped body. The irregularly-shaped body can have a string-like portion and/or a spherical-like portion. In some instances, the nodule 102 has a somewhat spherical shape. The nodule 102 has a nodule diameter na, which represents the largest length across or through the nodule. In some exemplary embodiments, the nodule diameter na is in the range of 1 mm to 10 mm. With a more irregularly shaped nodule (e.g., having a significant string-like portion), the nodule diameter na could be in the range of 10 mm to 38 mm or 10 mm to 51 mm. The nodule 102 is formed of glass fibers, which may or may not be held together with a binder (as described below). For example, the nodules could be formed in a manner similar to loosefill insulation product (using chopped/milled glass fibers).

In one exemplary embodiment, the fibrous (e.g., fiberglass) media 120 is a mat 122, as shown in FIG. 1B. The mat 122 is generally a planar-shaped body. The mat is generally a non-woven mat. For example, the mat could be formed in a manner similar to a fiberglass batt insulation product. The mat 122 may have any practical dimensions (i.e., thickness, width, and length). The mat 122 is typically cut (illustrated by dashed line 124) from a formed roll 126 of the fibrous material. Because the dimensions of the fibrous material are really only limited by its manufacturing and storing processes, the dimensions of the mat 122 can vary widely. In some exemplary embodiments, a thickness of the mat 122 is in the range of about 1 mm to about 50 mm. In some exemplary embodiments, a width of the mat 122 is in the range of about 10 mm to about 1 m. In some exemplary embodiments, a length of the mat 122 is in the range of about 10 mm to about 1,000 m. Often, the dimensions of the mat 122 will depend upon its intended application. For example, if the mat 122 is being placed into a furrow created by a piece of farm equipment, the mat 122 might have dimensions of 10 mm×50 mm×1,000 m.

Notwithstanding these illustrative embodiments, the general inventive concepts contemplate that the fibrous media can assume any form suitable for use as a growth media given the intended application (e.g., agriculture). By way of example, the fibrous media could simply be a quantity of loose fibers, a collection of entangled (e.g., needled) fibers, a quantity of texturized glass fibers (often referred to as “glass wool”), etc. Generally, the fibrous media will act as an inorganic soil amendment.

The fibrous media (e.g., fibrous media 100, 120) encompassed by the general inventive concepts will typically comprise glass fibers formed from a composition including: about 20 wt. % to about 75 wt. % of SiO₂; about 1 wt. % to about 30 wt. % of Al₂O₃; and about 1 wt. % to about 25 wt. % of Na₂O.

A glass composition used to form the fibrous media (e.g., fibrous media 100, 120) is typically suitable for melting using various types of furnaces (e.g., electric, gas, a combination of both) in both laboratory and manufacturing scale. The liquidus temperature and rheological working range of glasses for different manufacturing processes can be adjusted via the manipulation of the glass chemistry in the given range. A typical melting temperature for the glass composition ranges from 2,100° F. to 2,800° F., depending on the glass chemistry. The glass composition can be melted at a given temperature for 30 mins to several hours depending on the rheological properties and spatial-composition of the glass melts inside the furnace.

The fiberizing process (i.e., the process of forming fibers from the molten glass) can be performed by continuous and discontinuous methods including drawing from a precious metal bushing, a rotary process utilizing internal centrifuge, a cascade process using external centrifuge, a flame attenuation process, or a combination of one or more of these fiberizing techniques. For example, the fiberizing process can involve both the flame attenuation process and the rotary process to achieve a desirable fiber diameter, morphology, and surface area, as well as other physical properties and appearance of interest.

The glass fibers are attenuated from the device and are blown generally downwardly within a forming chamber so as to be deposited onto a forming conveyor. A chemical agent (e.g., a sizing composition) is applied to an outer surface of the glass fibers, as they are being formed, by means of suitable spray applicators to result in a uniform distribution of the chemical agent throughout a glass fiber mass. The chemical agent may be applied to the fibers as a solution or dispersion in an organic or aqueous medium. Often, the composition is applied to the fibers as an aqueous solution. The temperature of the glass and the surrounding forming area is usually high enough to evaporate the water from the aqueous solution before the fibers have been collected. A chemical agent could also be applied to the surface of a glass fiber at a subsequent step in the manufacturing process, after the fibers have been initially collected.

A chemical agent (e.g., a binder composition), such as a resin, could also be applied to the glass fibers during the manufacturing process to hold the fibers (i.e., the fiber mass) together. The necessity, as well as the type and amount, of the binder composition will typically depend on the form of the fibrous media, for example, loose fibers, an aggregate (e.g., the nodule 102), a sheet-like structure (e.g., the mat 122), etc.

Alternatively, in some exemplary embodiments, a binder is not used to hold the glass fibers together. As one example, the glass fibers could be held together by mechanical entanglement (e.g., needling).

Should the fibrous media be bonded with a binder, any suitable binder may be used. In some exemplary embodiments, the binder is based on a thermosetting binder. The binder may be a phenol-urea-formaldehyde (PUF), a phenol-formaldehyde (PF), or a non-added formaldehyde binder. Examples of non-added formaldehyde binders include, but are not limited to, polyesters, polyamides, and melanoidin-based binders. Polyester and polyamide-based binders may comprise monomeric or polymeric carboxylic acids; monomeric or polymeric polyols; and monomeric or polymeric amines, preferably primary or secondary amines. The melanoidin-based binder may be based on a reducing sugar and an amine or ammonia component. In some exemplary embodiments, the binder is based on a thermoplastic binder. Optionally, the binder may be mainly water-insoluble or mainly water-soluble. The binder may comprise processing aides like oils, silanes, silicones, and surfactants. Alternatively, the fibrous media may be mainly free of a binder and only contain processing aides, wherein the processing aides may comprise oils, silanes, silicones, and surfactants.

In some exemplary embodiments, one or more additives (e.g., functional components) can be incorporated into the sizing and/or the binder or the processing aides associated therewith. In this case, the sizing and/or the binder function as a release agent for the additives. Indeed, certain additives could be used to control the rate of release of other additives.

In some exemplary embodiments, the additives include protective additives for the plant that leach into the seed or soil when hydrated, such as herbicides, insecticides, nematicides, and/or fungicides.

In some exemplary embodiments, the additives include plant growth additives, such as nutrients or hormones.

In some exemplary embodiments, the additives include one or more agricultural biologicals.

In some exemplary embodiments, the additives include soil enrichening additives such as surfactants that enhance the water holding capacity of the soil (also known as “moisturizers” or “soil loosening agents” or “humectants”).

In some exemplary embodiments, the additives include an additive (e.g., a surfactant) that makes the glass fibers more hydrophilic, which in turn enhances the water holding capacity and subsequent water release ability of the fibrous media.

The average surface area of the glass fibers can range from 0.01 m²/g to 20 m²/g depending on the forming process and the glass chemistry that enables that process. Also, the morphology of the resultant fibers or bundles of fibers can be aligned, tortured, cross-linked, and woven depending on the post-fiberizing processing technology and the desired product form. The glass fibers will typically have a relatively large fiber diameter distribution ranging from about 0.1 μm to about 40 μm. However, the glass fibers used in the fibrous media will generally have an average fiber diameter in the range of about 1 μm to about 10 μm (or in the range of about 1 μm to about 5 μm), which is controlled by the fiberizing process and glass rheological properties at the designated operating temperature.

The high surface-area-to-volume ratio enables deposition of functional chemistry (e.g., nutrients, pesticides [weed, insect, fungus]) on the glass surface that would be released/activated by the infusion of water upon hydration. The surface-area-to-volume ratio is a function of the nodule density, glass density (which is essentially fixed, say 2,500 kg/m³), and fiber diameter as follows: A/V=4×(nodule density/glass density)×(1/fiber diameter). The fiberglass media will typically have a density in the range of about 240.28 kg/m³ to about 720.83 kg/m³ for soil-based applications, which corresponds to a surface-area-to-volume ratio in the range of about 38,444 m⁻¹ (assumes low density of 240 kg/m³ and high fiber diameter of 10 μm) to about 1,153,328 m⁻¹ (assumes high density of 720 kg/m³ and low fiber diameter of 1 μm).

Due to its high porosity (e.g., >95% open volume in some instances), the fiberglass media is able to hold a significant amount of liquid water within its volume when saturated. Likewise, the porosity of the fiberglass media is a function of its density. As noted above, the fiberglass media will typically have a density in the range of about 240.28 kg/m³ to about 720.83 kg/m³ for soil-based applications, which corresponds to a porosity in the range of about 3.76 cm³/gm to about 0.99 cm³/gm. The porosity of the fiberglass media can be readily controlled, at least for those embodiments where a binder is used to hold the glass fibers together.

The fibrous media is hydrated upon placement within the soil and slowly releases the water (extended hydration) and perhaps any intended chemistry (transport) to the soil, at the soil-media interface, initially and with repeated cycles of re-hydration.

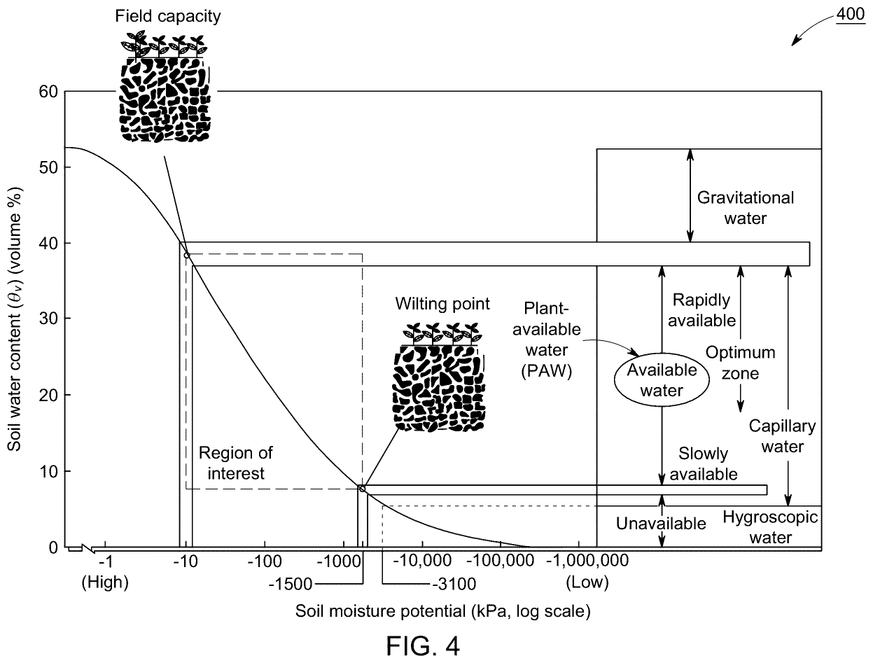

The efficacy of this release of water from the fibrous media could be assessed, for example, by measuring the plant-available water (PAW). As shown in the diagram 400 of FIG. 4—taken from R. Weil and N. Brady, The Nature and Properties of Soils (15^{th} edition, 2017), which illustrates the soil water characteristics curve (SWCC), the PAW is the difference between the field capacity (i.e., the maximum amount of water the soil can hold) and the wilting point (i.e., the point at which a plant can no longer extract water from the soil). Field capacity is determined by mass and measures the total % water content after thorough saturation followed by freely draining for 24 hours (or can be estimated by the water retention of the soil when subjected to 10 kPa of suction pressure). The permanent wilting point is determined by the Sunflower Method for Permanent Wilting Point. This method is designed to measure the moisture content of soils when a plant reaches the permanent wilting point (PWP). This point is where a plant wilts and can no longer recover its turgidity when placed in a saturated atmosphere for 12 hours. This method uses a dwarf sunflower bioassay. The PWP can also be estimated by the water retention of the soil when subjected to 1,500 kPa of suction pressure.

The SWCC shown in FIG. 4 shows the soil water content as a function of the soil moisture potential, which is also known as the matric pressure or potential. The curved line shows that at low matric pressures (less negative), the soil holds its maximum amount of water and at high matric pressures (more negative), the soil holds its least amount of water. There are several physical characteristics that correspond to approximate matric pressures, namely, saturation, field capacity, permanent wilting point, and plant-available water.

During a rain shower or irrigation application, the soil pores will be filled with water. If all soil pores are filled with water, the soil is said to be saturated. Since no air is present in the soil at saturation, the plant will suffer. Although there are exceptions, many crops cannot withstand saturated soil conditions for more than a few (e.g., 2 to 5) days. The period of saturation of the topsoil usually does not last long. After the rain or irrigation has stopped, part of the water present in the larger pores of the soil will move downward. This process is called drainage or percolation.

Field capacity is typically used interchangeably with the terms water holding capacity and water retention capacity. Field capacity is the amount of soil moisture or water content held in the soil after excess water has drained away and the rate of downward movement of the water has materially decreased, which usually takes place 2-3 days after a rain or irrigation in pervious soils of uniform structure and texture.

The permanent wilting point is the point when there is no water available to the plant. The permanent wilting point depends on plant variety, but it is usually around 1,500 kPa (15 bars). At this stage, the soil still contains some water, but it is difficult for the roots of the plant to extract the water from the soil. Nearly 1,500 kPa of tension is required to extract the water by the plant. At this limit, if no additional water is supplied to the soil, most plants die.

The soil can be considered a water reservoir for the plants. When the soil is saturated, the reservoir is full. However, some water drains rapidly below the root zone before the plant can use it. When this water has drained away, the soil is at field capacity. The plant roots draw water from what water remains in the reservoir. When the soil reaches the permanent wilting point, any remaining water is no longer available to the plant. The actual water available to the plant (i.e., the plant-available water) is the amount of water stored in the soil at field capacity minus the water that will remain in the soil at the permanent wilting point. The available water content is affected by the soil texture and structure.

In general, the fibrous media can achieve improved water-holding performance in the region of interest (shown in FIG. 4), which translates to the fibrous media increasing the plant-available water relative to the base soil alone.

In some exemplary embodiments, the fibrous media can achieve comparable or better levels of PAW at a lower dosage than some conventional soil amendments (e.g., silicas, biochar, mulch).

In some exemplary embodiments, the fibrous media can achieve comparable or better levels of PAW at a lower cost than some conventional soil amendments (e.g., SAPs).

In some exemplary embodiments, the fibrous media can avoid various drawbacks associated with conventional soil amendments, such as soil pH sensitivity (e.g., SAPs) and high material variability (biochar).

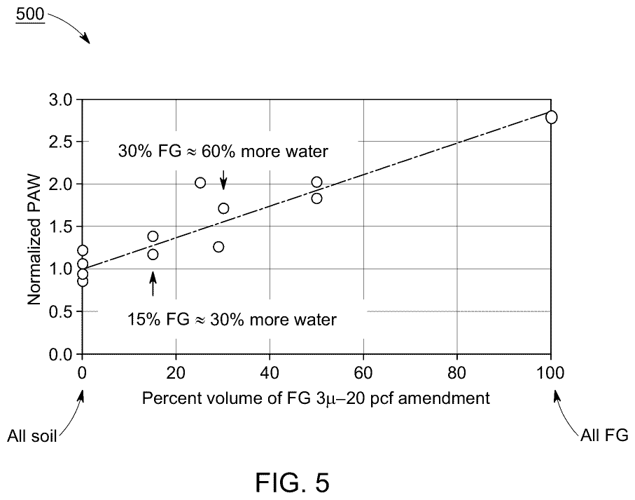

In a measurement of the SWCC, which will be described with reference to the graph 500 of FIG. 5, an embodiment of a fiberglass media (having an average fiber diameter of 3 μm and a density of 320.37 kg/m³) was introduced as a soil amendment. The SWCC and its importance was described with reference to the graph 400 of FIG. 4. Measurements in this study were obtained with a pressure/vacuum extraction technique where the specimens are positioned on a porous ceramic plate and the water is extracted from the specimen by the plate operating at a negative pressure relative to the soil. Once equilibrium was reached, the mass of the specimen was determined and then compared to its oven-dried mass, where the difference is the mass of water held at that suction level. Measurements for this work covered the pressure range from 10 kPa suction to 1,500 kPa suction. This pressure range was selected because, as noted above, it represents the field capacity on the low end and the permanent wilting point on the high end.

In the trial, the impact of soil amendment samples encompassing 0% by volume to 100% by volume of the fiberglass media (including 15%, 30%, and 50%) were assessed, with the base soil without any amendment therein representing 0% on the x-axis and the case where all of the soil is replaced with the fiberglass media representing 100% on the x-axis. Thus, the x-axis spans from 100% base soil to 100% fiberglass media, per a given volume. In the graph 500, the PAW of the base soil (without any of the fiberglass media therein) was normalized to a value of 1.0 on the y-axis. Thus, using this normalized scale and correlating the data points generated by the aforementioned samples, it was determined that the impact of the fiberglass media as a soil amendment scales linearly with the volume of the fiberglass media. This relationship is illustrated by the dashed line in FIG. 5. As shown in the graph 500, the fiberglass media exhibited the potential to hold nearly three (3) times more PAW than the soil, in this case a sandy loam soil.

It was surprisingly found that both the (average) fiber diameter of the fibers in the fiberglass media and the density of the fiberglass media were important to achieving an improved PAW, for example, a PAW greater than the soil without any amendment therein. In particular, as shown in Table 1, the efficacy of eight (8) different fiberglass media samples were evaluated. In particular, a first sample having a fiber diameter of about 3 μm and a density of about 64 kg/m³; a second sample having a fiber diameter of about 3 μm and a density of about 160 kg/m³; a third sample having a fiber diameter of about 3 μm and a density of about 320 kg/m³; a fourth sample having a fiber diameter of about 3 μm and a density of about 640 kg/m³; a fifth sample having a fiber diameter of about 11 μm and a density of about 64 kg/m³; a sixth sample having a fiber diameter of about 11 μm and a density of about 160 kg/m³; a seventh sample having a fiber diameter of about 11 μm and a density of about 320 kg/m³; and an eighth sample having a fiber diameter of about 11 μm and a density of about 640 kg/m³. As used herein, HT refers to hundred thousandths of an inch, with 1.0 μm being equal to approximately 3.94 HT.

TABLE 1

| | | | PAW Better | |
|---|---|---|---|---|
| Fiberglass Media Form | | | than Soil? | Measurement # |
| Fine Fiber | 64 kg/m³ | (4 pcf) | NO | 1 |
| (3 μm; 12 HT) | 160 kg/m³ | (10 pcf) | NO | 2 |
| | 320 kg/m³ | (20 pcf) | YES | 3 |
| | 640 kg/m³ | (40 pcf) | YES | 4 |
| Coarse Fiber | 64 kg/m³ | (4 pcf) | NO | 5 |
| (11 μm; 43 HT) | 160 kg/m³ | (10 pcf) | NO | 6 |
| | 320 kg/m³ | (20 pcf) | NO | 7 |
| | 640 kg/m³ | (40 pcf) | NO | 8 |

Thus, as shown in Table 1, a soil amendment comprising the fiberglass media made of fine fibers (e.g., having an average diameter of about 3 μm or about 12 HT) did not necessarily result in an increased PAW relative to the soil without any amendment. See measurement #1 and measurement #2. Likewise, a soil amendment comprising the fiberglass media with a density in the range of about 320.37 kg/m³ (about 20 pcf) to about 640.74 kg/m³ (about 40 pcf) did not necessarily result in an increased PAW relative to the soil without any amendment. See measurement #7 and measurement #8. However, a soil amendment comprising the fiberglass media made of fine fibers (e.g., having an average diameter of about 3 μm or 12 HT) and with a density in the range of about 320.37 kg/m³ (about 20 pcf) to about 640.74 kg/m³ (about 40 pcf) did result in an increased PAW relative to the soil without any amendment. See measurement #3 and measurement #4. Thus, the fibrous media embodiments described or suggested herein, which are based on this synergistic relationship between certain fiber diameters and certain densities of the fibrous media to achieve the necessary pore size to support the increased PAW, represent an improved soil amendment capable of achieving increased PAW.

The primary forces at play with water in a soil matrix are gravitational, directing the water downward, and capillarity, holding the water within the matrix. This capillarity (or capillary pressure) results from the surface tension of the liquid and the pore sizes that contain the liquid. This is described by the Laplace equation (1) that is derived from a force balance at the meniscus of a circular cross section and is given by:

$${P}_{c} = \frac{2 γcosθ}{{r}_{p}} \qquad ( 1 )$$

where: P_{c} is the capillary pressure, γ is the interfacial surface tension, rₚ is the effective radius of the interface, and θ is the wetting angle of the liquid on the surface of the capillary.

For a plant-based application, γ will primarily be the surface tension of water (0.072 N/m, unless surfactants are used), and θ will be representative of the surface energy of the material at hand, which in this case is glass. Glass is known to have high surface energy and therefore a low wetting angle, so θ would be expected to be low, causing cos θ to approach unity and maximize the capillary pressure.

The effective pore size of the fiber web can be estimated based on a unit free-cell approach where the cross section of a circular fiber is surrounded by a ring of liquid that is attributed to that fiber (a ring around the fiber composed of liquid). By using the force balance of the weight of the column of water due to gravity and the force from surface tension at the air-water-fiber interface, it can be readily shown that the effective pore radius of a fiberglass web is given by equation (2):

$${r}_{p} = {r}_{f} ( \frac{{ρ}_{f}}{{ρ}_{w}} - 1 ) \qquad ( 2 )$$

where: r_{f} is the fiber radius, ρ_{f} is the density of an individual glass fiber (say 2,500 kg/m³), and ρ_{w} is the density of the fiberglass web.

Combining Equations (1) and (2) gives a direct relationship between the capillary pressure and the physical characteristics of the fiberglass web, which is represented by equation (3):

$${P}_{c} = \frac{2 γcosθ}{{r}_{f} ( \frac{{ρ}_{f}}{{ρ}_{w}} - 1 )} . \qquad ( 3 )$$

Diagram 400 of FIG. 4 shows that an ideal soil amendment made of fiberglass should be able to release its water at pressures somewhere between about 10 kPa (field capacity) and about 1,500 kPa (permanent wilting point). Release of water at pressures below this range would be vulnerable to free drainage, and release of water at pressures above this range would be too tightly held for the plant to extract it. Equation (3) allows for estimation of the fiber radius (r_{f}) and web density (ρ_{w}) combinations that will yield the target capillary pressure.

Assuming values for the surface tension (0.072 N/m), wetting angle (θ≈0), and individual fiber density (2,500 kg/m³), Table 2 shows the combinations of fiber diameter (D_{f}) and web density (ρ_{w}) that are required to deliver certain capillary pressures (P_{c}). The web density shown for 10 kPa (field capacity for a soil-based application) and 3 μm fiber diameter—which represents a minimum—is supported by the successful densities shown in Table 1 (320-640 kg/m³).

TABLE 2
P_{c} = 10 kPa

| D_{f} (μm) | ρ_{w} (kg/m³) |
|---|---|
| 1 | 83.9 |
| 3 | 235.8 |
| 5 | 369.8 |
| 7 | 488.8 |

Thus, the general inventive concepts encompass an effective fiberglass media for promoting crop/plant growth. The average diameter of the fibers forming the fiberglass media is in the range of about 1 μm (about 3.94 HT) to about 7 μm (about 27.58 HT), more preferably about 2 μm (about 7.87 HT) to about 4 μm (about 15.75 HT), and most preferably about 3 μm (about 11.81 HT). Additionally, the density of the fiberglass media is in the range of about 240.28 kg/m³ (about 15 pcf or lb/ft³) to about 720.83 kg/m³ (about 45 pcf), more preferably about 272.31 kg/m³ (about 17 pcf) to about 688.79 kg/m³ (about 43 pcf), even more preferably about 304.35 kg/m³ (about 19 pcf) to about 656.76 kg/m³ (about 41 pcf), and more preferably about 320.37 kg/m³ (about 20 pcf) to about 640.74 kg/m³ (about 40 pcf).

As noted above, various forms of fibrous media (e.g., fibrous media 100, 120) can be achieved downstream of the fiberizing section, including a nodule 102 (see FIG. 1A) and a mat 122 (see FIG. 1B).

The glass fibers can be blown into a forming chamber where they are deposited with little organization, or in varying patterns, onto a traveling conveyor so as to form a mat. Subsequently, the coated fibrous mat, which would include a binder as a chemical agent, is transferred out of the forming chamber to a transfer zone where the mat vertically expands due to the resiliency of the fibers. The coated mat is then transferred to a curing oven, where heated air is blown through the mat, or to a curing mold, where heat may be applied under pressure, to cure the binder and rigidly attach the fibers together. This mat product can then be used as a planting media, as described herein.

Other types of fibrous products include fibers that are not bound or held together by a binder. In this case, the fibers are blown into a forming chamber where they are deposited with little organization, or in varying patterns, onto a traveling conveyor (so as to form a mat) or into a duct for transport. Subsequently, the fibrous mat is transferred out of the forming chamber to a transfer zone where the fibers may expand due to their resiliency.

The expanded fibers can then be sent through a mill (e.g., a hammermill) to be cut apart where chemical agents could also be added. The fibers once formed, may be pulverized, cut, chopped or broken into suitable lengths for the plant growth application. Several devices and methods are available to produce short pieces of fibers and are known in the art. The resulting fibrous products could take the form of nodules, which are roughly spherical in shape and have a diameter that ranges from about 1 mm to about 10 mm. These nodules could be used directly as a soil additive.

The form of the fibrous media (e.g., nodule 102, mat 122) being used will typically depend on the particular application. Some suitable applications include, but are not limited to, various agricultural applications, various landscaping applications, and various gardening applications. In general, the fibrous media may be used in any suitable soil-based agriculture or plant application, including for turf and lawn grasses.

By increasing the PAW in the amended soil, the fibrous media may allow crops and plants to grow in regions previously considered too arid to support growth. By increasing the PAW in the amended soil, the fibrous media may support the cultivation of crops and plants using significantly less water. By increasing the PAW in the amended soil, the fibrous media may allow certain crops and plants not naturally able to thrive in the soil to flourish.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications thereto. It is sought, therefore, to cover all such changes and modifications as fall within the spirit and scope of the general inventive concepts, as described and/or claimed herein, and any equivalents thereof.

What is claimed is:

1. A soil amendment comprising a plurality of discrete fibers, wherein the fibers have an average fiber diameter in the range of about 1 μm to about 5 μm;
wherein the soil amendment has a density in the range of about 240.28 kg/m³ to about 720.83 kg/m³; and
wherein the soil amendment is operable to increase the plant-available water level of the soil by at least about 30% when the soil amendment replaces about 15% by volume of the soil.

2. The soil amendment of claim 1, wherein the fibers are glass fibers.

3. The soil amendment of claim 2, wherein the glass fibers comprise about 20 wt. % to about 75 wt. % of SiO₂, about 1 wt. % to about 15 wt. % of Al₂O₃, and about 2 wt. % to about 25 wt. % of Na₂O.

4. The soil amendment of claim 2, wherein the glass fibers have a ratio of Si to (Si+Al) greater than about 0.7.

5. The soil amendment of claim 1, wherein the fibers have an average fiber diameter in the range of about 2 μm to about 4 μm; and
wherein the soil amendment has a density in the range of about 272.31 kg/m³ to about 688.79 kg/m³.

6. The soil amendment of claim 1, wherein the fibers have an average fiber diameter of about 3 μm; and
wherein the soil amendment has a density in the range of about 320.37 kg/m³ to about 640.74 kg/m³.

7. The soil amendment of claim 1, wherein the fibers have an average fiber diameter of about 3 μm; and
wherein the soil amendment has a density in the range of about 304.35 kg/m³ to about 656.76 kg/m³.

8. The soil amendment of claim 1, wherein the fibers form a plurality of nodules having an average largest linear dimension in the range of about 1 mm to about 10 mm.

9. The soil amendment of claim 8, wherein each of the nodules has a spherical shape and the largest linear dimension is a diameter of the spherical shape.

10. The soil amendment of claim 1, wherein the fibers form a non-woven mat having a width, a length, and a thickness.

11. The soil amendment of claim 10, wherein the width is in the range of about 10 mm to about 1 m;
wherein the length is in the range of about 10 mm to about 1,000 m; and
wherein the thickness is in the range of about 1 mm to about 50 mm.

12. The soil amendment of claim 10, wherein the fibers of the mat are held together by a binder.

13. The soil amendment of claim 10, wherein the fibers of the mat are held together by mechanical entanglement.

14. The soil amendment of claim 1, further comprising an additive applied to a surface of the fibers.

15. The soil amendment of claim 14, wherein the additive is at least one of a herbicide, an insecticide, a nematicide, and a fungicide.

16. The soil amendment of claim 14, wherein the additive is a hormone.

17. The soil amendment of claim 14, wherein the additive is an agricultural biological.

18. The soil amendment of claim 14, wherein the additive is a surfactant.

19. The soil amendment of claim 1, wherein the fibers comprise a quantity of hydrophilic fibers and a quantity of hydrophobic fibers.
